(19) United States
(12) Patent Application Publication
(10) Pub. No.: US 2022/0245748 A1
(43) Pub. Date: Aug. 4, 2022

(54) VEHICLE SHARING SYSTEM

(71) Applicant: ALLSTATE INSURANCE COMPANY, Northbrook, IL (US)

(72) Inventors: Mike Flossmor, Northbrook, IL (US); Mark E. Faga, Evanston, IL (US); Howard Hayes, Glencoe, IL (US)

(21) Appl. No.: 17/591,228

(22) Filed: Feb. 2, 2022

Related U.S. Application Data
(60) Provisional application No. 63/145,065, filed on Feb. 3, 2021.

(51) Int. Cl. G06Q 50/30; G06Q 50/00

(52) U.S. Cl. CPC G06Q 50/30; G06Q 30/0282; G06Q 50/01

(57) ABSTRACT

Aspects of the present disclosure provide systems and methods for vehicle sharing. One aspect includes a vehicle sharing system including a data collection component configured to receive vehicle owner information and user information. The vehicle sharing system may also include a matching component configured to determine a match between a vehicle owner and a vehicle user based on the vehicle owner information and the user information. In some aspects, the vehicle owner information includes vehicle owner social data and the user information includes vehicle user social data. The vehicle sharing system may also include a communication interface configured to send an indication of the match between the vehicle owner and the vehicle user.

### CROSS-REFERENCE TO RELATED APPLICATION

This application claims the benefit of priority to U.S. Provisional Patent Application No. 63/145,065, filed on Feb. 3, 2021, which is incorporated by reference herein in its entirety as if fully set forth herein.

### FIELD

Certain aspects of the disclosure generally relate to methods and systems for vehicle sharing. More specifically, certain aspects of this disclosure relate to a vehicle sharing system that facilitates sharing of vehicles between vehicle owners and users.

### BACKGROUND

Some households or individuals may have one or more vehicles that are not being used at various times. For example, some members of a household may purchase a vehicle for commuting to work and subsequently begin working from home, such that use of the vehicle decreases. At the same time, other households may experience an increased demand for a vehicle and not have access to other vehicles. Such demand may be on a temporary basis where the household may not wish to purchase a vehicle to meet this demand. Accordingly, vehicle availability, needs, and access may dynamically change for both owners and users at various points in time. It is with these observations in mind, among others, that aspects of the presently disclosed technology were conceived and developed.

### SUMMARY

Implementations of the present disclosure involve systems and methods for vehicle sharing. In one implementation, a data collection component is in communication with a plurality of user devices and a plurality of owner devices over a network. Each of the plurality of owner devices is associated with a corresponding vehicle owner of a plurality of vehicle owners, and each of the plurality of user devices is associated with a corresponding vehicle user of a plurality of vehicle users. The plurality of vehicle owners provides corresponding vehicles, and each of the plurality of vehicle users is requesting vehicle sharing. The data collection component receives vehicle owner information from each of the plurality of owner devices and user information from each of the plurality of user devices. A matching component is configured to determine a match between a first vehicle owner of the plurality of vehicle owners and a first vehicle user of the plurality of vehicle users based on the vehicle owner information and the user information. The vehicle owner information includes vehicle owner social data and the user information includes vehicle user social data. A communication interface is configured to send an indication of the match between the first vehicle owner and the first vehicle user. The indication specifies a first vehicle of the corresponding vehicles, with the first vehicle associated with the first vehicle owner.

In another implementation, vehicle owner information is received from a plurality of owner devices by a data collection component of a vehicle sharing system. Each of the plurality of owner devices is associated with a corresponding vehicle owner of a plurality of vehicle owners, and the plurality of vehicle owners provide corresponding vehicles. User information is received from a plurality of user devices. Each of the plurality of user devices is associated with a corresponding vehicle user of a plurality of vehicle users, and each of the plurality of vehicle users is requesting vehicle sharing. A match is determined between a first vehicle owner of the plurality of vehicle owners and a first vehicle user of the plurality of vehicle users based on the vehicle owner information and the user information. The match specifies a first vehicle of the corresponding vehicles. The first vehicle is associated with the first vehicle owner. The match determined using a matching component of the vehicle sharing system. A vehicle sharing rate is determined for the first vehicle based on at least one of vehicle owner historical telematics data associated with the first vehicle owner or user historical telematics data associated with the first vehicle user. The vehicle sharing rate is determined by a rate detection component of the vehicle sharing system. An indication of the match and the vehicle sharing rate is sent to a first owner device of the plurality of owner devices and a first user vehicle of the plurality of user devices. The first owner device is associated with the first vehicle owner, and the first user device is associated with the first vehicle user.

In another implementation, vehicle owner information is received from a plurality of owner devices by a data collection component of a vehicle sharing system. Each of the plurality of owner devices is associated with a corresponding vehicle owner of a plurality of vehicle owners. The plurality of vehicle owners provides corresponding vehicles. User information is received from a plurality of user devices. Each of the plurality of user devices is associated with a corresponding vehicle user of a plurality of vehicle users. Each of the plurality of vehicle users requesting vehicle sharing. One or more vehicle availability patterns of each of the plurality of vehicle owners is determined based on the vehicle owner information. One or more vehicle usage patterns of each of the plurality of vehicle users is determined based on the user information. A mobility behavior match of a first vehicle owner of the plurality of vehicle owners and a first vehicle user of the plurality of vehicle users is determined based on the one or more vehicle availability patterns of the first vehicle owner and the one or more vehicle usage patterns of the first vehicle user. An indication of the mobility behavior match is generated, with the indication of the mobility behavior match being sent to at least one of a first owner device of the plurality of owner devices or a first user device of the plurality of user devices. The first owner device may be associated with the first vehicle owner and the first user device may be associated with the vehicle user.

In another implementation, a data collection component is configured to receive vehicle owner information from each of a plurality of vehicle owners to commit a vehicle for vehicle sharing on a vehicle sharing application executing on the vehicle sharing system. The data collection component is further configured to receive user information from each of a plurality of vehicle users requesting vehicle sharing on the vehicle sharing application executing on the vehicle sharing system. A matching component is configured to determine a match between a vehicle owner of the plurality of vehicle owners and a vehicle user of the plurality of vehicle users based on the vehicle owner information and the user information. The vehicle owner information includes vehicle owner social data, and the user information includes vehicle user social data. A communication interface is configured to send an indication of the match between the vehicle owner and the vehicle user.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example computing device for vehicle sharing.

FIG. 2 is an exemplary method of peer-to-peer vehicle sharing.

FIG. 3 is a diagram illustrating an example vehicle sharing system.

FIG. 4A is a block diagram illustrating an example matching component of a vehicle sharing system.

FIG. 4B is a diagram illustrating an example matching algorithm.

FIG. 4C is a block diagram illustrating an example matching component of a vehicle sharing system.

FIG. 4D is an exemplary user device illustrating the vehicle sharing system.

FIG. 5 illustrates example operations for vehicle sharing.

FIG. 6 illustrates example operations for vehicle sharing using a pricing system.

FIG. 7 illustrates example operations for vehicle sharing using a driver scoring system.

FIG. 8 illustrates example operations for vehicle sharing using a mobility behavior system.

FIG. 9 is a flow diagram illustrating example operations for vehicle sharing using social data.

FIG. 10 is a flow diagram illustrating example operations for vehicle sharing using rate detection.

FIG. 11 is a flow diagram illustrating example operations for vehicle sharing using mobility behavior.

### DETAILED DESCRIPTION

Certain aspects of the present disclosure are directed towards systems and methods for vehicle sharing. In one aspect, in a peer-to-peer vehicle sharing service, users who have a vehicle may make their vehicle available to a vehicle sharing service. The vehicle may be rented by another user who wants to borrow such a vehicle. Demand for vehicle rental in a peer-to-peer vehicle sharing service is generally matched with the supply available at the same (e.g., within a predefined proximity) location. There is generally an inherent lack of trust between the vehicle owner and a potential user, creating concerns about trust and security of the vehicle sharing. For example, there may be a lack of trust in the value being exchanged, such as whether the vehicle being rented has been well-maintained.

Additionally, there may be a lack of trust between the vehicle owner and the user, such as trust in whether the vehicle owner will show up to provide the vehicle for rent, whether the user will return the vehicle, or whether the user will return the vehicle in acceptable form. There may also be a lack of trust in the peer-to-peer vehicle sharing marketplace itself.

Accordingly, the presently disclosed technology addresses these concerns by promoting trust between vehicle owners and vehicle users, allowing the sharing of vehicles, among other advantages. For example, social data may be used to promote trust. Some aspects also provide techniques for determining a rate for sharing a vehicle based on a scoring of vehicle users and owners. In some aspects, a vehicle sharing system may determine, based on historical vehicle supply data and based on historical vehicle demand data, that vehicle demand will exceed vehicle supply on a particular date and send a request to provide a vehicle for sharing on that date.

In the following description of the various aspects of the disclosure, reference is made to the accompanying drawings, which form a part hereof, and in which is shown by way of illustration, various aspects in which the disclosure may be practiced. It is to be understood that other aspects may be utilized and structural and functional modifications may be made. In one or more arrangements, aspects of the present disclosure may be implemented with a computing device.

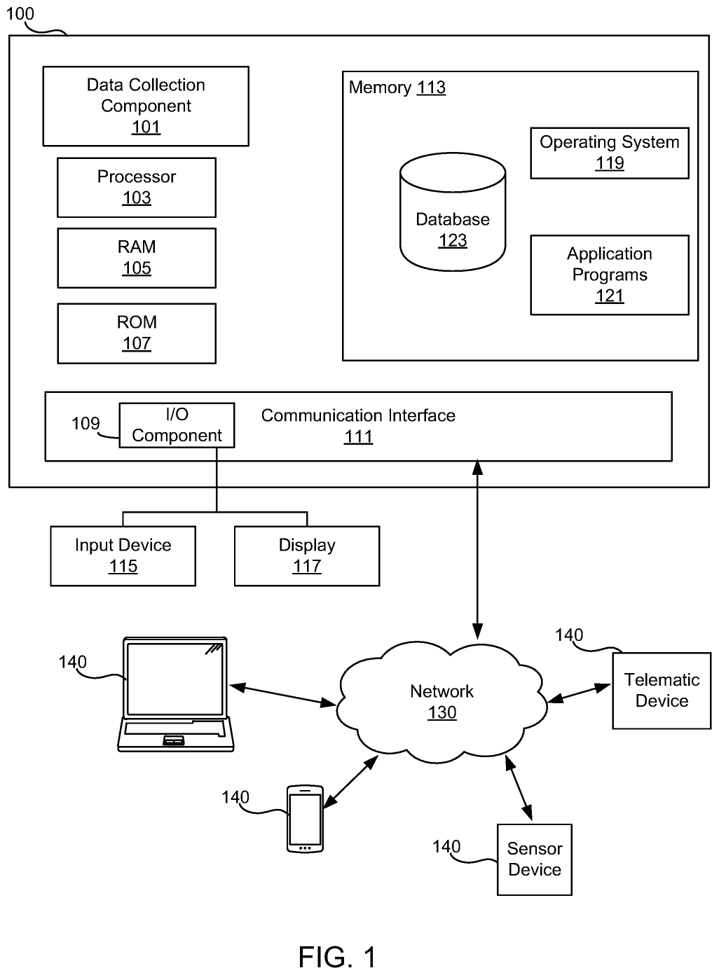

FIG. 1 illustrates a block diagram of an example computing device 100 that may be used in accordance with aspects described herein. The computing device 100 may be a server, personal computer (e.g., a desktop computer), laptop computer, notebook, tablet, smartphone, home management devices, home security devices, smart appliances, etc. The computing device 100 may have a data collection component 101 for retrieving and/or analyzing data as described herein.

The data collection component 101 may be implemented with one or more processors and one or more storage units (e.g., databases, RAM, ROM, and other computer-readable media), one or more application specific integrated circuits (ASICs), and/or other hardware components (e.g., resistors, capacitors, power sources, switches, multiplexers, transistors, inverters, etc.). Throughout this disclosure, the data collection component 101 may refer to the software and/or hardware and/or applications used to implement the data collection component 101. In cases where the data collection component 101 includes one or more processors, such processors may be specially configured to perform the processes disclosed herein. Additionally, or alternatively, the data collection component 101 may include one or more processors configured to execute computer-executable instructions, which may be stored on a storage medium, to perform the processes disclosed herein. In some examples, computing device 100 may include one or more processors 103 in addition to, or instead of, the data collection component 101. The processor(s) 103 may be configured to operate in conjunction with data collection component 101. Both the data collection component 101 and the processor(s) 103 may be capable of controlling operations of the computing device 100 and its associated components, including RAM 105, ROM 107, an input/output (I/O) component 109, a network interface 111, and memory 113. For example, the data collection component 101 and processor(s) 103 may each be configured to read/write computer-executable instructions and other values from/to the RAM 105, ROM 107, and memory 113.

The I/O component 109 may be configured to be connected to an input device 115, such as a microphone, keypad, keyboard, touchscreen, and/or stylus through which a user of the computing device 100 may provide input data. The I/O component 109 may also be configured to be connected to a display device 117, such as a monitor, television, touchscreen, etc., and may include a graphics card. The display device 117 and input device 115 are shown as separate elements from the computing device 100; however, they may be within the same structure. On some computing devices 100, the input device 115 may be operated by users to interact with the data collection component 101, including providing user information and/or preferences, account information, vehicle sharing requests and/or offers, etc., as described in further detail below. System administrators may use the input device 115 to make updates to the data collection component 101, such as software updates. Meanwhile, the display device 117 may assist the system administrators and users to confirm/appreciate their inputs.

The memory 113 may be any computer-readable medium for storing computer-executable instructions (e.g., software). The instructions stored within memory 113 may enable the computing device 100 to perform various functions. For example, memory 113 may store software used by the computing device 100, such as an operating system 119 and vehicle sharing application 121, and may include an associated database 123.

The network interface 111 may allow the computing device 100 to connect to and communicate with a network 130. The network 130 may be any type of network, including a local area network (LAN) and/or a wide area network (WAN), such as the Internet, a cellular network, or a satellite network. Through the network 130, the computing device 100 may communicate with one or more other devices 140 (e.g., a mobile computing device, such as laptops, notebooks, smartphones, cell phones, tablets, personal computers, in-vehicle devices, servers, vehicles, home management devices, home security devices, smart appliances, etc.). The mobile computing devices 140 may be configured to operate software and/or applications. The mobile computing devices 140 may also be configured in a similar manner as computing device 100. In some aspects, the computing device 100 may be connected to the mobile computing devices 140 to form a “cloud” computing environment. The mobile computing devices 140 may include, for example, owner devices, user devices, and/or the like.

The devices 140 may include an in-vehicle device 140. The present disclosure may utilize an in-vehicle device 140 to collect and provide telematics information. For example, the in-vehicle device may include a telematic device 140. The in-vehicle device 140 may include a processor with a display or graphical interface that receives and/or collects driving data and/or telematics information and provides additional information based on the driving data. The driving data, GPS information, and/or telematics information may include, but not be limited to: location, instantaneous velocity, average velocity, route, destination, etc. The in-vehicle device 140, which may be configured to receive real-time vehicle data, may provide a driver or the vehicle owner with visual and/or audible in-vehicle information. The in-vehicle device 140 may process real-time (i.e., near real-time) data and then display the processed information in a meaningful way on a display or graphical user interface (GUI). The in-vehicle device 140 may receive and/or collect critical driving data and store summary information for and/or about the driver.

The in-vehicle device 140 may communicate with a data collection device or on-board diagnostics port of a vehicle to collect the driving data. In another exemplary aspect, the in-vehicle device 140 may acquire the driving data directly from the device, such as a smartphone, tablet computer, or vehicle navigation system via a built-in accelerometer and/or a Global Positioning System (GPS).

The network interface 111 may connect to the network 130 via communication lines, such as coaxial cable, fiber optic cable, etc., or wirelessly using a cellular backhaul or a wireless standard, such as IEEE 802.11, IEEE 802.15, IEEE 802.16, etc. In some aspects, the network interface may include a modem. Further, the network interface 111 may use various protocols, including TCP/IP, Ethernet, File Transfer Protocol (FTP), Hypertext Transfer Protocol (HTTP), etc., to communicate with other mobile computing devices 140.

At any point in time, some households are increasing the number of vehicles they own in response to increasing demand (which is often caused by changing life circumstances). At the same time, other households experience decreased demand for vehicles that they already own. Eventually, a household may decide to dispose of the extra vehicle(s), but have available capacity parked someplace until they sell the vehicle. Matching these households is the key objective of a vehicle sharing system described herein. Hence, there is a need for a dynamic matching system that is continually adjusting for changing household vehicle ownership status.

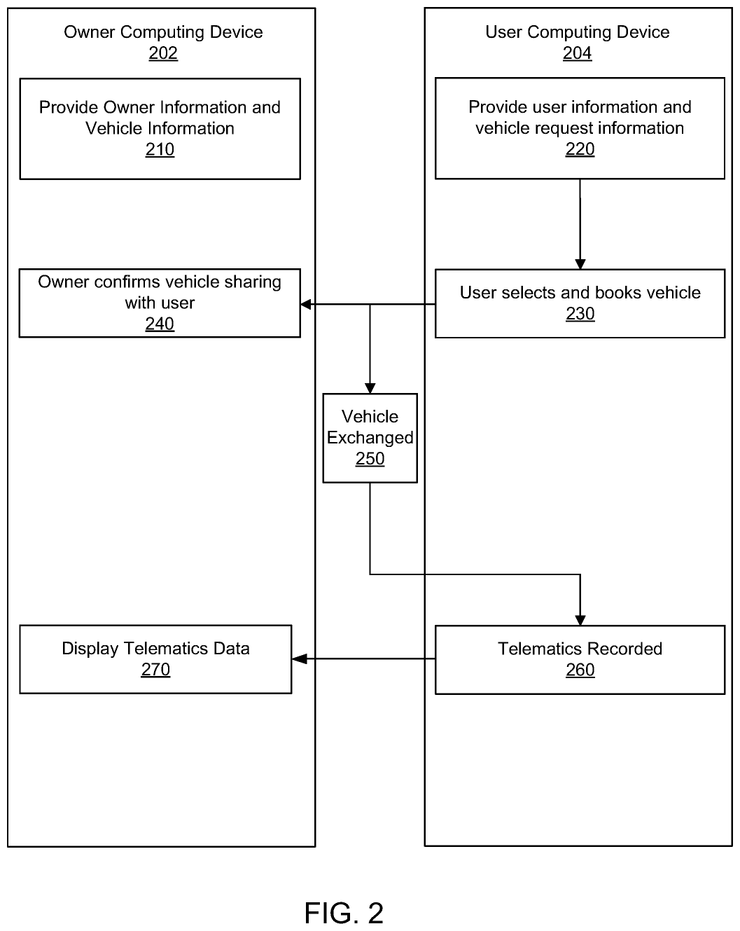

FIG. 2 is an exemplary method of peer-to-peer vehicle sharing and connecting vehicle owners to users in accordance with one or more aspects described herein. At block 210, a vehicle owner computing device provides vehicle owner information for verification to a vehicle sharing system. The vehicle owner computing device may be a mobile computing device. The vehicle owner information may be provided through a web browser or web application on a personal computing system. The vehicle owner device may provide owner information, such as name, address, age, and any other pertinent information. The vehicle owner may also provide vehicle information, such as make, model, year, color, mileage, condition, amenities/features, etc.

At block 220, a user device (e.g., of a user who wants to share a vehicle) may provide user information and vehicle request information to a vehicle sharing system. The vehicle request information may include search parameters such as location, available dates/times, vehicle make/model, mileage, condition, or features. A list of available vehicles may be presented to the user based on the user information and vehicle request information. In some aspects, to find one or more matching vehicles for vehicle sharing, the owner information, vehicle information, user information, and vehicle request information may be provided to a vehicle sharing system, as described in more detail herein. The vehicle sharing system may be part of a server, or part of any suitable computing device, such as the user computing device 204

In some aspects, the user may search for a desired vehicle via the user device 204. In some cases, the user may search for a vehicle using location or other search parameters in an online marketplace. The user device 204 may also receive (e.g., from a vehicle user) personal information to be provided to the vehicle sharing system to facilitate the generation of candidate vehicles available for sharing, as described. The vehicle sharing system may also have additional information on the user, such as previous vehicle sharing experiences, driving scores, credit scores, etc.

At block 230, the user device 204 selects and books a vehicle. For example, the user device 204 may be presented with a list of vehicles (e.g., matching vehicle) that meet the user's search parameters and the user may select one of the vehicles to borrow. At block 240, the vehicle owner computing device 202 is contacted regarding the vehicle sharing with the user and the vehicle owner computing device 202 confirms the vehicle sharing with the user.

At block 250, the vehicle is exchanged between the vehicle owner and the user. Various suitable techniques for exchanging the vehicle between the owner and user may be used. At block 260, the user device 204 may record telematics data while the user is using the vehicle, which is provided to the vehicle owner computing device 202. At block 270, the telematics data may be displayed to the vehicle owner to promote confidence and trust that the vehicle is being properly taken care of. For example, the vehicle owner device 202 may monitor the user's driving behavior either in real-time or after events associated with the vehicle's operation. The user may then return the shared vehicle to the owner. Other actions may occur after the return of the shared vehicle, such as payment from the user to the vehicle owner and/or ratings from the user and from the owner of the shared vehicle experience.

In addition to serving a transportation need, the vehicle sharing system may match a) people with excess vehicle supply with b) people in need of transportation (e.g., having a vehicle need). A dynamic matching system may be used to connect the right potential users to vehicle owners successfully. The complexity (and opportunity) is that households are regularly in flux with respect to vehicle ownership. As such, it is challenging to match people who have unused vehicles with people who need transportation. Without a match-making platform, people with excess supply can't readily locate people in need of transportation, and vice versa.

Certain aspects address a challenge associated with establishing trust for transactions to occur in a vehicle sharing marketplace (e.g., an online peer-to-peer marketplace). Unlike traditional vehicle purchases or renting, trust needs to be generated between two “strangers” for transactions to occur.

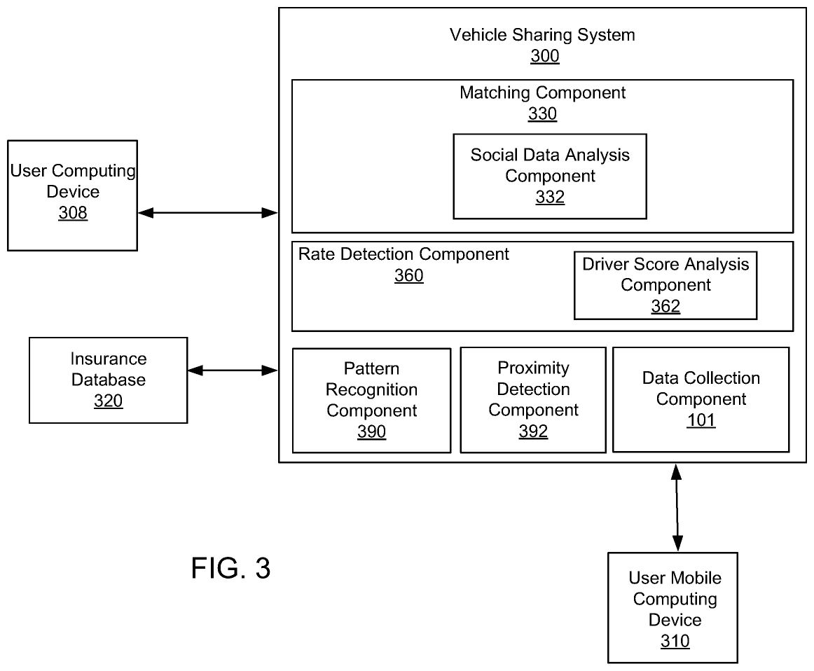

FIG. 3 is a diagram illustrating a vehicle sharing system 300 in accordance with one or more aspects described herein. In some instances, the vehicle sharing system 300 may include one or more computing devices, such as computing device 100 or mobile computing devices 140, or aspects similar to those discussed herein with respect to computing device 100 and mobile computing devices 140. In some aspects, the vehicle sharing system 300 may be implemented as part of a vehicle user device and/or a vehicle owner device, facilitating peer-to-peer vehicle sharing.

The vehicle sharing system 300 may collect information from, and transmit information to, a user through various channels, such as via a user mobile computing device 310, or via a user computing device 308 (e.g., via one or more public or private networks). In some aspects, the vehicle sharing system 300 may receive a request from a user to share a vehicle and may store information related to the request in memory or in a database, such as database 123 of FIG. 1. For example, a consumer may use a web browser, or other application, executing on user computing device 308 to send the request to vehicle sharing system 300. In some aspects, the request may include information conveying an identity of the user, a type or class of vehicle wanted, a date for the vehicle sharing, a duration for the vehicle sharing, and one or more locations, such as a pickup location and a drop off location.

Upon receiving the request, vehicle sharing system 300 may determine whether a vehicle matching the type of vehicle requested is available for the date, duration, and/or location requested. For example, the vehicle sharing system 300 may determine that one or more vehicles matching the type requested are available and parked at the requested location. The one or more vehicles may be selected for being within a predefined distance of a location as determined or identified by longitude and latitude, zip code, physical address of a building or structure at a user requested location, or the like. In some aspects, the vehicle sharing system 300 may flag one of these vehicles as reserved and may prevent the reserved vehicle from being rented by other users. In some aspects, the vehicle sharing system 300 may accept the user's request and store information related to the request in memory or in a database, such as database 123 of FIG. 1. In other aspects, the vehicle sharing system 300 may determine that a vehicle of the type requested is expected to be available on the date in the user's request.

As further illustrated in FIG. 3, the vehicle sharing system 300 may include one or more of a matching component 330, a rate detection component 360, a pattern recognition component 390, a proximity detection component, and data collection component 301.

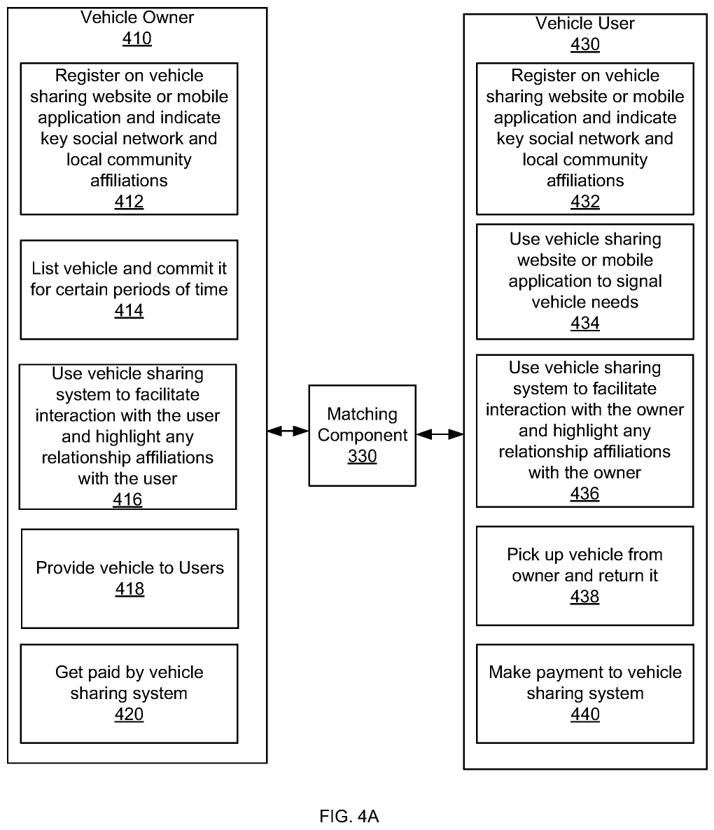

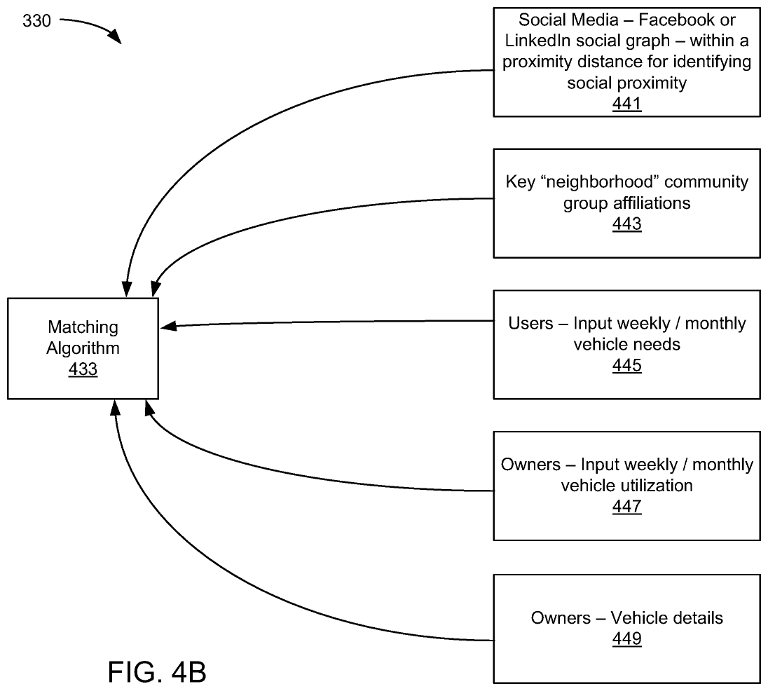

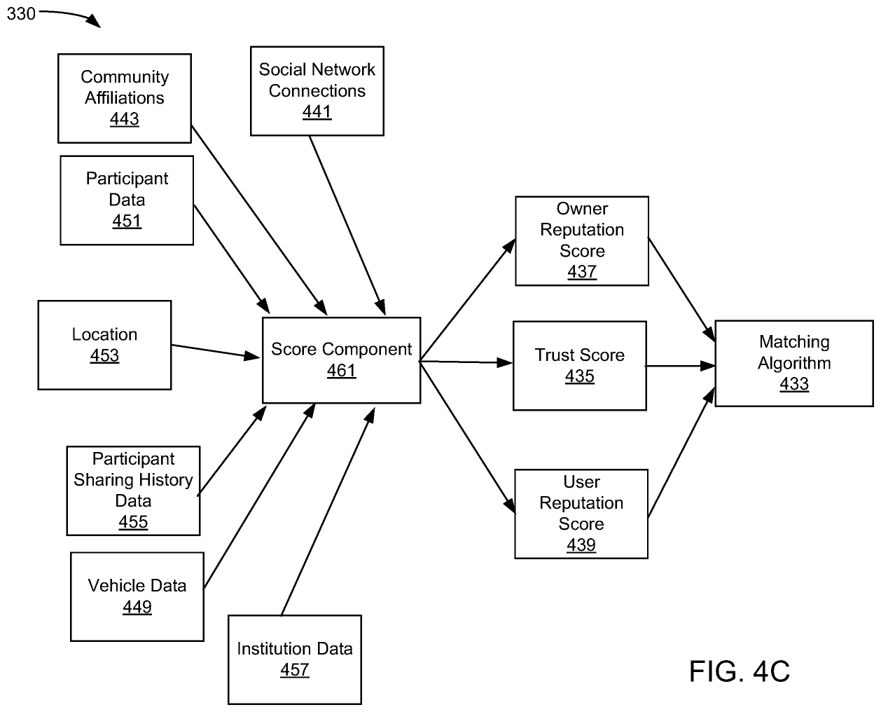

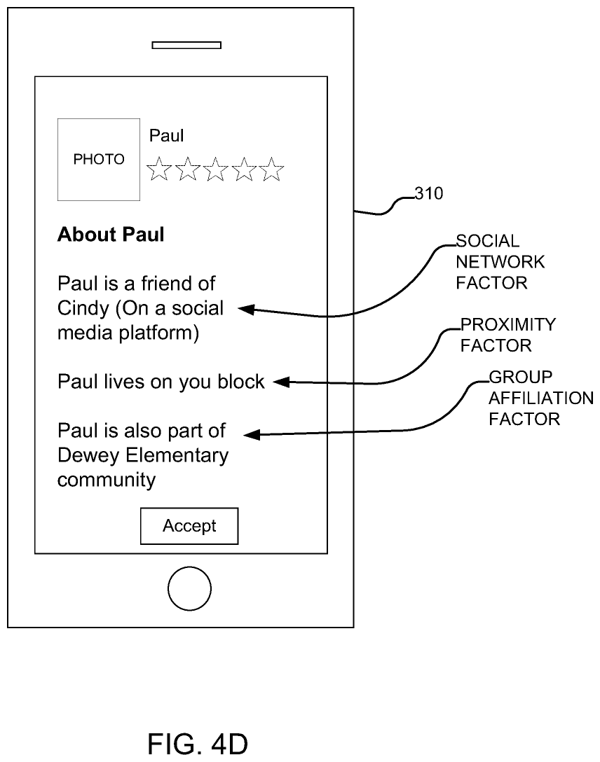

The matching component 330, as will be detailed further with FIGS. 4A-4D, may provide a system of trust and safety nets for participants in the vehicle sharing market. The matching component 330 may use multiple factors with a matching algorithm for the vehicle owners and the users to build primary, secondary, and tertiary connections between peer-to-peer vehicle sharing participants. For example, the trust component may include a social data analysis component 332 that analyzes social media connections or community affiliations of users and vehicle owners, allowing the vehicle owners and user to be matched based on their social connections.

The rate detection component 360 may provide a vehicle sharing price based on pattern driving telematics. For example, a vehicle owner may allow their vehicle to be shared for a period of time. The rate for the shared time may be based on one or more of the following: (1) the user's past personal telematics information, (2) the vehicle owner's past personal telematics information, (3) the vehicle lifetime telematics information, (4) insurance information regarding the vehicle owner or the vehicle user, or (5) the projected route (e.g., and its interplay with the vehicle owner's personal telematics and the vehicle's telematics). The rate detection component 360 may include a driver score analysis component 362 that may analyze these factors and provide a driver score to the user and/or vehicle owner. Based on the driver score, the rate for vehicle sharing may be calculated by the rate detection component 360.

In some aspects, matching component 330 may provide a “yes/no” decision on a vehicle sharing decision depending on a proposed user's driving score (e.g., as determined by driver score analysis component 362) and driving characteristics. For example, a vehicle owner could indicate that they will not share their vehicle with anyone with telematics information showing they drove over 90 mph. The results of this decision may be used by the vehicle sharing system 300 to determine whether to match a particular user with a specific vehicle owner for vehicle sharing.

The vehicle sharing system 300 and the rate detection component 360 may consider factors in determining the vehicle sharing price. The rate detection component 360 may set the vehicle sharing price by using dynamic pricing that is based on the user's risk and/or trust factor. Additionally, rate detection component 360 may set the price and/or provide a recommendation to the vehicle owner, with the vehicle owner ultimately setting the final price. Depending on demand, rate detection component 360 may set the vehicle sharing price higher or lower. Additionally, rate detection component 360 may set the vehicle sharing price by using dynamic pricing based on demand.

The vehicle sharing system 300 may also include a pattern recognition component 390. The pattern recognition component 390 may match the mobility behavior of vehicle owners (or users) with the mobility behavior of the users (or vehicle owners). Because the vehicle sharing system 300 includes telematics data about users and vehicle owners, the pattern recognition component 390 may identify patterns of driver use, such as when people are driving, when people are not driving, and when people need to drive. The pattern recognition component 390 may then recommend users based upon availability and use patterns of the various pool of participants. For example, person A that uses a vehicle on weekends, but not during the week, may be matched with person B who uses a vehicle on a weekday, but not during the weekends. In this manner, a vehicle from only one person may be used to meet the demand of person B. Similarly, pattern recognition component 390 may also notify a user of potential vehicle sharing matches based on the user's mobility behaviors for vehicle sharing.

In some aspects, the matching component 330 may match vehicle owners and users based on vehicle type. For example, if person A prefers a particular vehicle type that person B has for sharing, then person A and person B may be matched. Additionally, the matching component 330 may match vehicles owners and users based on the location of the vehicle and users.

In some aspects, based on input from the pattern recognition component 390, the matching component 330 may match vehicle owners and users such that the mobility behavior of vehicle owners/users are paired with the inverse mobility behavior of users/vehicle owners. The data collection component 101 may retrieve a map of inventory of vehicles in real-time to assist with matching the vehicle owners and users. In some aspects, the vehicle sharing system 300 may notify a vehicle owner on how much the vehicle owner could earn by sharing his/her vehicle.

In some aspects, the proximity detection component 392 may receive, from the data collection component 101, an indication of locations of vehicles and locations of users requesting vehicles. The proximity detection component 392 may filter the vehicles that are candidates for matching with each user based on proximity from each vehicle to the user. For example, a particular user may request that any vehicle match is within a specific distance to the user. Therefore, the matching component 330 may receive an indication of a subset of vehicles that meet this criteria, and perform the matching from the subset of vehicles.

In some arrangements, the vehicle sharing system 300 may be connected to an insurance system, such as insurance database 320. The insurance database 320 may include insurance information that may reside on an insurance server. The insurance information may include information about a vehicle owner or a particular user, previous accidents, previous claims, information about other users with similar characteristics, etc. The insurance database 320 may be configured to use the insurance information known about the vehicle owner or a particular user and insurance information about users with similar characteristics to provide additional information to the vehicle sharing system 300. For example, the driver score analysis component 362 may use this information to provide a driver score for a vehicle user to be considered for rate detection. The insurance database 320 may also include information about the user, the residences or other locations at which vehicles associated with the user are frequently parked, vehicles that the user owns, and the locations of the vehicles. The information from the insurance database 320 may be used for vehicle matching based on user or owner preferences. For instance, a vehicle owner may prefer that a user has not been in any accidents within the past five years. This information may be retrieved from the insurance database and used for vehicle matching.

In some aspects, the vehicle sharing system 300 may cause insurance charges related to a user's personal vehicle to be reduced while the user borrows a vehicle from the vehicle sharing system 300. For example, the vehicle sharing system 300 may access the insurance database 320 to obtain information about the user's owned vehicle and may cause a reduction in charges for their insurance during a period in which they borrow a vehicle using the vehicle sharing system 300. In some aspects, the vehicle sharing system 300 may cause a user's personal vehicle insurance to be suspended or paused, during the shared period. For example, the vehicle sharing system 300 may send an indication to an insurance company that the vehicle was being driven by a user for vehicle sharing, along with a time duration associated with the vehicle sharing, allowing the insurance company to compensate the vehicle owner for the time period that the vehicle was being shared. The vehicle sharing system 300 may use the insurance database 320 and set the vehicle sharing price by crediting the user's insurance bill for the vehicle sharing. The vehicle sharing system 300 may provide an insurance credit for the time when the owner's vehicle is being shared because the vehicle is not on the owner's policy. For example, suppose person A is insuring the vehicle for $100/month insurance and person A shares the vehicle with person B. In that case, person B pays $50 for a week of insurance and a certain amount is reimbursed back to person A from the insurer. In some aspects, insurance may be built into the vehicle sharing price if the user uses the application. The vehicle sharing system 300 may collect all the same information to properly price insurance for the rental and this cost of insurance may be included in the vehicle sharing price.

FIGS. 4A-4D illustrate operations for vehicle sharing while building trust between vehicle owners and users, in accordance with certain aspects of the present disclosure. The vehicle sharing system 300 may engender trust among strangers by utilizing the matching component 330. Example techniques for using matching component 330 of the vehicle sharing system 300 is shown in FIG. 4A. The vehicle sharing system 300 may connect vehicle owners to any potential user in the immediate local vicinity (e.g., a neighborhood). The vehicle sharing system 300 may integrate “community” elements that will increase trust in the marketplace. The lack of trust is an important factor to address in the peer-to-peer marketplace and current businesses. For example, the vehicle sharing system 300 may integrate social/community affiliations to match vehicle owners and users. Integrating community elements has the potential to reduce the “stranger” anxiety and fits well with the inherently local nature of transportation services, such as peer-to-peer vehicle sharing. Ideally, the vehicle sharing system 300 would convey the sense of being a neighborhood service with support and protections provided by a trustworthy institution that has neighborhood ties.

The vehicle sharing system 300 may create a two-sided marketplace matching framework, including the development of potential use of local social networks and community affiliations in the peer-to-peer vehicle sharing marketplace. Additionally, the vehicle sharing system 300 may include a “trust creation framework” (e.g., as implemented by the matching component 330) including a machine-learning algorithm to analyze various ways consumers build trust and how the vehicle sharing system 300 can facilitate trust-building among vehicle owners and users and between the institution, vehicle owners, and users. The machine learning algorithm is discussed in more detail herein with respect to FIG. 4B.

The interaction between vehicle owners and vehicle users with an exemplary matching component 330 is shown in FIG. 4A. The matching component 330 may leverage community relationships as catalysts to create trust and increase interactions between vehicle owners and vehicle users.

At block 412, a vehicle owner device 410 may register a vehicle owner and a vehicle on a vehicle sharing application, website, or mobile application (e.g., an application program such as vehicle sharing application 121 of FIG. 1). The vehicle owner device 410 may also indicate key social network information and/or local community affiliations to help with the matching analysis performed by the matching component 330. Additionally, at block 432, a vehicle user device 430 may register on a vehicle sharing application, website, or mobile application (e.g., vehicle sharing application 121 of FIG. 1) and list personal information (e.g., also referred to herein as user information) associated with the vehicle user. The vehicle user device may also indicate key social network information and/or local community affiliations to help with the matching analysis of the matching component 330.

At block 414, the vehicle owner device 410 may list a vehicle and commit the vehicle for certain periods of time and/or days. Additionally, at block 434, the vehicle user device 430 may use the vehicle sharing application, website, or vehicle sharing application 121 to signal and provide any vehicle preferences, to include search parameters, such as location, available dates/times, vehicle make/model, mileage, condition, features, etc.

At blocks 416, 436, the vehicle sharing system 300, including the matching component 330, may be used to facilitate interaction between the vehicle owner and the vehicle user. The matching component 330 may also highlight any relationship affiliations between the vehicle owner and the vehicle user. The relationship affiliations and facilitated interaction between the vehicle owner and the vehicle user help to leverage the common relationships (e.g., community, family, friends, and/or professional) as catalysts to create trust and increase interactions between the vehicle owner and the vehicle user. For example, social data as collected at blocks 412, 432 may be provided to the matching component 330 to perform vehicle matching using community connections and affiliations. Once the matching component 330 matches the vehicle owner and the vehicle user, the detected match is indicated to the vehicle owner and vehicle user. At blocks 418, 438, the vehicle owner may provide the selected vehicle to the vehicle user. The vehicle user may pick up the vehicle from the vehicle owner and subsequently return the vehicle after use.

At blocks 420, 440, the vehicle owner may be paid through the vehicle sharing system 300 and the vehicle user may make payment for the vehicle use through the vehicle sharing system 300. Other actions may occur following the use, such as ratings by both the vehicle owner and the vehicle user on the experience of the vehicle sharing use. The vehicle user's telematics data during the vehicle sharing use may be recorded and saved for future vehicle sharing instances. The vehicle user may also rate the vehicle, such as condition, features, accuracy of the listing, etc.

FIG. 4B is a diagram illustrating a matching algorithm 433 used to implement the matching component 330 of the vehicle sharing system 300, in accordance with certain aspects of the present disclosure. As described, the matching component 330 may be used for building mechanisms of trust. The nature of peer-peer vehicle sharing creates some risks for participants. For vehicle owners, their vehicle can get dinged up, abused by reckless driving, dirtied, permeated by cigarette smoke, or not returned on time among other risks. For vehicle users, the vehicle reservation may get canceled. The vehicle user may risk their safety driving in a vehicle that may not be well maintained or their physical safety may be in danger picking up a vehicle in an isolated area. Safety, security, and trust may be the strongest negatives about the concept of peer-to-peer vehicle sharing.

There may be three levels of the trust system. The first level of trust is in the idea of the exchange itself. People have to trust that the very notion of peer-to-peer vehicle sharing is safe. As consumers engage with other crowd-sourced markets, people start to accept these markets and gradually change their behavior.

The second level of trust is in the platform or institution that is brokering the service. They may trust the brand, insurance, the vetting process with background checks and safety requirements, the technology provided, and the brand standing behind it. For example, consumers understand that an insurance institution may have a history of fairly handling claims and the financial backing and experience to make things right. The insurance institution may also bring technology experience with telematics to create an oversight layer.

The third level of trust in peer-to-peer networks is between network participants. There are two types of interpersonal trust: cognitive trust (logical trust) and affect-based trust (cognitive trust). Cognitive trust means providing logic for trustworthiness through mechanisms such as dual rating systems, referrals, and transparency in the behaviors of the participants. Affect-based trust is often built through face-to-face interactions, or between members of the same community with something in common. The vehicle sharing system 300 can generate trust through standard mechanisms such as dual ratings, connecting neighbors, and surfacing nascent social connections. By considering these three levels of trust, the vehicle sharing system 300 provides a trust system that can encourage more vehicles to be rented out and rentals that address the real risks participants face.

The vehicle sharing system 300 may expose local connections to owners and users to raise trust. Lending vehicles to friends and family is a common behavior in society. There is potential to piggyback on this natural behavior by building on social proximity. There are already relationships between people through social and neighborhood connections that the vehicle sharing system 300 can leverage. The connection could be primary: between family and close friends, a secondary connection within a larger social group, or tertiary where location and weak ties create a surprisingly strong link.

Transportation is inherently local. The sharing may originate in one's neighborhood for peer-to-peer vehicle sharing. The proximity presents the opportunity to cultivate neighborhood affiliations to build trust in the peer-to-peer vehicle sharing marketplace. The following are example key affiliations: proximity of location (e.g., within a 3-mile radius), common friends (e.g., on Facebook); professional connections (e.g., on LinkedIn or same workplace); parent-teacher associations (“PTA”); religious organizations (e.g., church, synagogue); local charities; local sports clubs (e.g., little league); or alma mater connections. The vehicle owner may not know the user personally but if that person happens to live within a 3-mile radius, or is a “friend of a friend,” or a member of a common local group (e.g., PTA), then that “stranger” no longer seems so strange.

The vehicle sharing system 300 may match innovation and leverage local social and community affiliations. Whether the use case is for frequent use or infrequent use, local social networks and memberships in local organizations can be used to algorithmically assess the “degrees of separation” within a neighborhood (within ˜3-mile proximity to a vehicle owner) for individuals using the peer-to-peer vehicle sharing marketplace. The vehicle sharing system 300 may then introduce a vehicle owner to a potential vehicle user based on the various trust factors described.

The vehicle sharing system 300 may provide a trusted neighborhood marketplace for easily sharing the vehicle the user desires directly from vehicle owners. The vehicle sharing system 300 may emphasize and build primary, secondary, and tertiary connections between marketplace participants. First, the matching component 330 may leverage existing customer insurance data to identify likely participants and possible connections between people. For instance, the matching component 330 may use telematics data to understand what vehicles largely sit idle and thus be good candidates for sharing in the area. Second, the matching component 330 may construct the peer-to-peer vehicle sharing marketplace to facilitate connections to social networks. Vehicle owners can promote their vehicles to the local community through social and neighborhood networks.

The vehicle sharing system 300 may provide vehicle monitoring to provide a worry-free experience for vehicle owners. Vehicle monitoring and tracking are important for providing trust and peace of mind for vehicle owners. The vehicle monitoring and tracking may provide greater visibility into the use of the shared vehicle. The vehicle owners can see whether the vehicle has been driven safely and whether anything has occurred that would potentially damage the vehicle. The vehicle monitoring may be provided by one or more vehicle-connected services. For example, for the vehicle user, a mobile device (such as mobile computing device 310 shown in FIG. 3) may provide one or more of the following: motion monitoring, parking tracker, vehicle sharing insurance, roadside assistance, or speed limit alerts. For the vehicle owner, an on-board diagnostics (OBD)-device or telematics device 140 (e.g., which may be part of the vehicle being shared) may provide one or more of the following: automated crash alert, engine diagnostics, geo-fence alerts, live vehicle location tracking, maintenance alerts, or trip tracking and logging.

As shown in FIG. 4B, the matching algorithm 433 may determine a match of vehicle owners and vehicle users for vehicle sharing at a location based on various factors. The matching algorithm 433 may use machine learning to determine the best matching between vehicle owners and vehicle users. For example, the matching algorithm 433 may use machine learning algorithms, such as supervised learning and employ supervised algorithms, such as linear regression, random forest, nearest neighbor, decision trees, Support Vector Machines (SVM), and/or logistical regression, among others. In some other examples, the matching algorithm 433 may use unsupervised learning and employ unsupervised algorithms, such as k-means clustering and/or association rules. In still other examples, the matching algorithm 433 may use semi-supervised learning and/or reinforcement learning. The machine learning algorithm may be trained using historical matching results along with the associated factors and ratings provided by vehicle sharing users and owners. Once trained, the trained machine learning algorithm may be implemented as the matching algorithm 433.

Inputs to the matching algorithm 433 may include various factors as illustrated in FIG. 4B. For example, one of the factors to the matching algorithm 433 may be social data information, such as social media information 441 (e.g., social media connections). The social data may be analyzed by the matching algorithm using the social data analysis component 332 as described with respect to FIG. 3. The social media information 441 input may include Facebook, LinkedIn, or other social media websites and a social graph. The social media information 441 may also include a proximity distance between the vehicle owner and vehicle user. The social media information 441 may also be from first-order friends, family, or connections and second and third-order friends, family, or connections.

The matching algorithm 433 may also use the factor of key neighborhood group affiliations 443 between the vehicle owners and the vehicle users. For example, the key neighborhood group affiliations 443 may include school connections, gym memberships, church and religious connections, sports organizations, children's school connections, professional connections and organization, etc. The matching algorithm 433 may also factor a vehicle user's input of weekly/monthly vehicle needs 445 to match the vehicle users with vehicle owners who have vehicles that meet the vehicle user's weekly/monthly vehicle needs. The matching algorithm 433 may also factor a vehicle owner's weekly/monthly vehicle usage 447 to match the vehicle owners with vehicle users who have a vehicle need that meets the vehicle owner's weekly/monthly vehicle usage 447. The matching algorithm 433 may also factor in the vehicle owner's vehicle data 449 when matching vehicle owners and vehicle users. The vehicle user may request a certain type of vehicle, and the vehicle data 449 may include any of the various search parameters, such as vehicle make/model, year, mileage, condition, features, etc.

In some aspects, a machine learning algorithm (e.g., used to implement the matching algorithm 433) may be trained. For example, the machine learning algorithm may be trained on information collected over a period of time. The matching algorithm 433 may consider various factors for matching vehicles owners and vehicle users, such as location; degrees of separation (same groups, same friends); scores and ratings (e.g., driving score, reputation score, or vehicle sharing score); whether the vehicle user previously drove a vehicle owned by a person connected to one of the vehicle owner's friends, neighbors, or groups; whether the vehicle owner previously provided a vehicle to a person connected to one of the vehicle user's friends, neighbors, or groups; previous ratings of the vehicle owner; previous ratings of the vehicle user; whether the vehicle user (or vehicle owner previously drove (or provided) a vehicle in the same zip code or neighborhood as the vehicle owner (or vehicle user); vehicle owner and vehicle user reputation score; a matching with respect to the same type of driving behavior (e.g., of the vehicle owner and user); a matching with respect to the same type of driving score (e.g., of the vehicle owner and user); or price range of the vehicle. In some aspects, this information may be gathered, stored, or provided by the data collection component 101 of FIG. 1.

FIG. 4C illustrates further details of an implementation of the matching component 330. As shown in FIG. 4C, various factors and inputs may feed into the matching component 330, as detailed and described regarding FIG. 4B. Those various inputs for both the vehicle owner and the vehicle user may include, but are not to be limited to, social media information 441 (e.g., social media network connections), community affiliations 443, participant (vehicle owner and vehicle user) data 451, location information and social proximity 453, participant (vehicle owner and vehicle user) vehicle sharing history data 455, vehicle data 449, and institution data 457. Institution data 457 may refer to the organization facilitating the vehicle sharing and the vehicle sharing system 300.

As further illustrated in FIG. 4C, a scoring component 461 of the matching component 330 may determine a trust score 435 for the vehicle owner and/or the vehicle user based on the different factors. The social data analysis component 332 may be part of the scoring component 461. The scoring component 461 may generate the trust score 435 using factors that include one or more of the individual history, proximity of residence, timeliness, cancellations, social proximity, age, institution, trusting the vehicle (maintenance records and owner), or the vehicle owner and vehicle user reputation score. The matching component 330 may match a user to the vehicle owner with whom they have the most connections based on the trust score. For example, if the trust score 435 is above a specific threshold, the vehicle owner and vehicle user may be determined as a potential match. In some aspects, a vehicle owner may set thresholds based on preferences. For instance, the vehicle owner or user may set a particular threshold for the trust score or specify a threshold for one or more of the various factors considered. For example, the vehicle owner may indicate that they want to share the vehicle with only people that are part of his social media friends (or friends of friends). The matching component 330 may use the trust score 435 in combination with an owner reputation score 437 and a user reputation score 439 to help match a vehicle owner and a vehicle user, in some aspects. The scoring component 461 may be provided with pictures, reputation systems, or social media information to engender trust among strangers and determine the owner reputation score 437 and the user reputation score 439. For example, the scoring component 461 may detect that the owner of the vehicle and the user are connected because the user used to babysit for the owner's next-door neighbor, resulting in an increase in the trust score 435.

Additionally, the scoring component 461 may use telematics information by tracking the GPS of the vehicles, driver behavior (score user of the vehicles), or vehicle behavior to generate the trust score 435. The vehicle behavior may include a score of prior uses of the vehicle. The scoring component 461 may also use insurance information for both the vehicle owner or the user including previous insurance claims, previous accidents, and/or previous history with insurance (e.g., ten years on the same policy) to generate the trust score 435. The scoring component 461 may provide this telematics information and insurance information from the vehicle owner and the user.

FIG. 4D illustrates an exemplary user mobile computing device 310 with various examples of connections from the matching component 330, in accordance with certain aspects of the present disclosure. The user mobile computing device 310 is from a vehicle owner and shows an exemplary vehicle request for an all-day rental on Saturday from a user, Paul. In this example, the matching component 330 finds various connections between the vehicle owner and the potential vehicle user, Paul, and indicates the connections to the mobile computing device 310 for display. For example, the user mobile computing device 310 includes “Paul is a friend of Cindy (a social media platform)” which is a social network connection factor. The user mobile computing device 310 also includes “Paul lives on your block” which is location information and social proximity connection factor. The user mobile computing device 310 also includes “Paul is also part of Dewey Elementary community” which is a key neighborhood group affiliation connection factor. Based on these connections, the vehicle owner has built additional trust in the potential vehicle user, Paul. The vehicle owner can now select “Accept” to accept this vehicle sharing request.

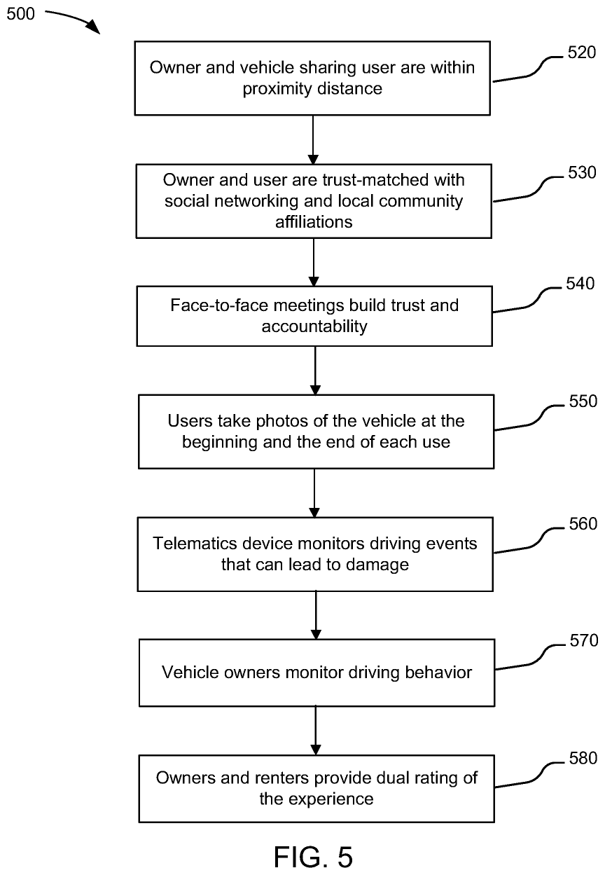

FIG. 5 is a flow diagram illustrating example operations 500 for vehicle sharing, in accordance with certain aspects of the present disclosure. In some aspects, operations 500 may be performed by the vehicle sharing system 300. The vehicle sharing system may be part of a server or any computing device (e.g., a computing device of a vehicle user). As described herein, an institution brand may stand behind the vehicle sharing service and provide trust and reputation to the vehicle sharing system 300 and specifically provide trust to vehicle owners and users.

At block 520, the vehicle sharing system (e.g., matching component 330) may determine that a vehicle owner and a vehicle sharing user are within a proximity distance. For example, this proximity distance may be an approximately 3-mile radius. Other proximity distances may be used, such as a 5-mile radius, 10-mile radius, 25-mile radius, or 50-mile radius.

At block 530, the vehicle sharing system (e.g., matching component 330) matches the vehicle owner and the vehicle sharing user using social data such as social networking information 441 and local community affiliations 443. Other factors may be used as described herein with respect to FIG. 4C, such as participant (vehicle owner and vehicle user) data 451, location information and social proximity 453, participant (vehicle owner and vehicle user) vehicle sharing history data 455, vehicle data 449, and institution data 457. The matching component 330 may match the vehicle owner and the vehicle sharing user using one or more of these various factors. At block 540, the vehicle sharing system 300 may facilitate a face-to-face meeting between the vehicle owner and the vehicle sharing user to build trust and accountability. For example, the vehicle sharing system 300 may indicate to the vehicle owner device and vehicle user device an agreed-upon time and place for the face-to-face meetup.

At block 550, the vehicle sharing system 300 may facilitate the vehicle sharing user to take photographs or capture images of the vehicle at the beginning and the end of each use. This will help confirm the safe usage of the shared vehicle during the shared time. For example, the vehicle sharing system 300 may receive the photos from the vehicle sharing user and store the photos in memory.

At block 560, the vehicle sharing system 300 may receive, from a telematics device (e.g., telematics device 140) on the shared vehicle, information for monitoring driving events that can or may lead to damage, such as high speed, high acceleration, hard braking, dangerous turns, etc. The in-vehicle telematics device 140, which may be configured to receive real-time vehicle data, may provide a driver or the vehicle owner with visual and/or audible in-vehicle information.

At block 570, the vehicle sharing system 300 may process real-time (or near real-time) data from the telematics device 140 and display the processed information from the vehicle usage in a meaningful way on a display or graphical user interface (GUI) to the vehicle owner. For example, the information may be sent to a computing device of the vehicle owner for display. The vehicle sharing system 300 may receive and/or collect driving data and store summary information for and/or about the vehicle user during the vehicle sharing.

At block 580, the vehicle sharing system 300 may receive ratings from the vehicle owner and the vehicle user. For example, the vehicle owner may rate various factors, such as the vehicle user interactions and ease of the vehicle sharing experience, the vehicle condition upon return, and any damage to the vehicle, etc. Additionally, the vehicle user may rate various factors, such as, the vehicle owner interactions, ease of the vehicle sharing experience, safety of the vehicle sharing experience, the vehicle condition, the vehicle features, and the accuracy of the vehicle listing, etc.

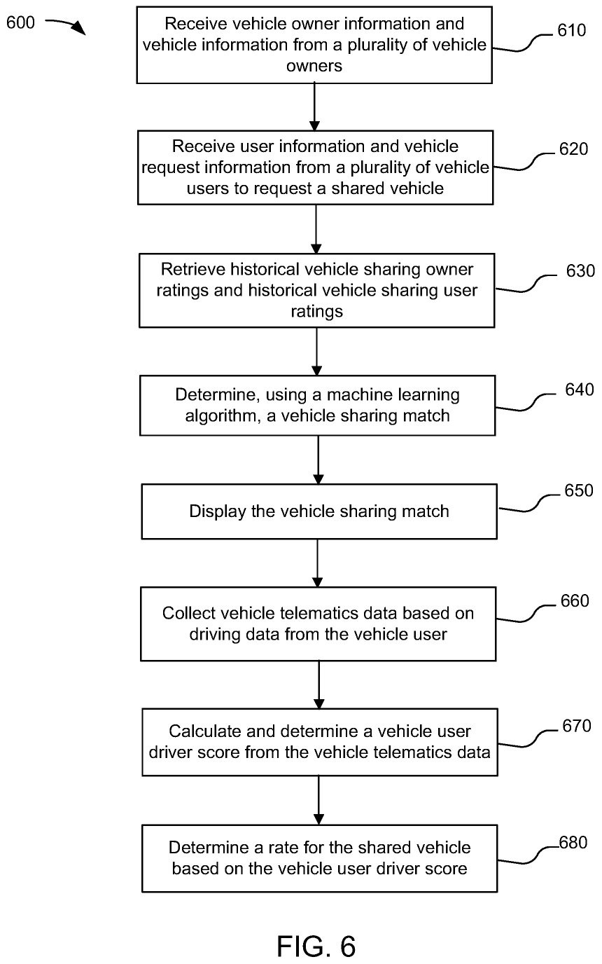

FIG. 6 is a flow diagram illustrating example operations 600 for vehicle sharing, in accordance with certain aspects of the present disclosure. In some aspects, operations 600 may be performed by the vehicle sharing system 300, including the matching component 330 and/or the rate detection component 360.

At block 610, the vehicle sharing system 300 receives vehicle owner information and vehicle information from a plurality of vehicle owners to commit a shared vehicle on a vehicle sharing application (e.g., vehicle sharing application 121). The vehicle sharing application 121 may execute on the vehicle sharing system 300. The vehicle owner information may include one or more of the following: vehicle owner location, vehicle owner social media connections, or vehicle owner community affiliations. The vehicle information may include one or more of the following: vehicle utilization by the vehicle owner, vehicle make and model, vehicle features, or vehicle conditions.

At block 620, the vehicle sharing system 300 receives user information and vehicle request information from a plurality of vehicle users to request a shared vehicle on a vehicle sharing application. The user information may include one or more of the following: user location, user social media connections, and user community affiliations. The vehicle request information may include one or more of the following: vehicle needs of the vehicle user, vehicle request make and model, vehicle request features, and vehicle request condition.

At block 630, the vehicle sharing system 300 retrieves historical vehicle sharing owner ratings and historical vehicle sharing user ratings. The historical vehicle sharing owner ratings may be compared to the ratings of other vehicle owners. The historical vehicle sharing user ratings may be compared to the ratings of other vehicle users. These ratings may be retrieved from records of the vehicle owner and vehicle user's previous experiences with the vehicle sharing application 121 and vehicle sharing system 300. A star system may be used for the rating system. Additionally, a number rating system from 1-5 or 1-10, for example, may also be used for the rating system. The rating system may include an area for comments to be included from the previous vehicle sharing experiences for the vehicle owner and/or the vehicle user.

At block 640, the vehicle sharing system 300 determines, using the matching component 330 (e.g., a machine learning component), a vehicle sharing match between one of the plurality of vehicle owners and one of the plurality of vehicle users. The vehicle sharing match may be based on one or more of the following: matching the vehicle owner location with the vehicle user location within a proximity distance, matching the vehicle owner social media connections with the vehicle user social media connections, or matching the vehicle owner community affiliations with the vehicle user community affiliations. The vehicle sharing match may also be based on comparing (e.g., matching) the vehicle information and the vehicle request information. The vehicle sharing match may also be based on the historical vehicle sharing owner ratings and the historical vehicle sharing user ratings. The matching component 330 may use one or more of the following factors for the vehicle sharing match: location; degrees of separation (same groups, same friends); scores and ratings (e.g., driving score, reputation score, or vehicle sharing score); whether the user previously drove vehicle owned by a person connected to one of the owner's friends, neighbors, or groups; whether the vehicle owner previously provided a vehicle to a person connected to one of the user's friends, neighbors, or groups; previous ratings of the vehicle owner; previous ratings of the vehicle user; whether the user (or owner) previously drove (or provided) vehicle in same zip code or neighborhood as the owner (or user); vehicle owner and vehicle user reputation score; matching of the same type of driving behavior (vehicle owner and user); matching of the same type of driving score (vehicle owner and user); or price range of the vehicle.

At block 650, the vehicle sharing system 300 displays the vehicle sharing match. The vehicle sharing system 300 may display the vehicle sharing match on a user interface of a computing device of the vehicle owner and/or the vehicle user. In some aspects, the vehicle sharing system 300 may display various vehicle sharing matches (e.g., potential vehicles for a user) in order of best match or best matching score.

At block 660, the vehicle sharing system 300 collects vehicle telematics data based on driving data associated with the vehicle user. Specifically, a telematics device 140 connected to the vehicle sharing application 121 executing on the vehicle sharing system 300 may collect the telematics data. The telematics data may include driving events that can or may lead to damage, such as high speed, high acceleration, hard braking, dangerous turns, etc.

At block 670, the vehicle sharing system 300 calculates and determines a vehicle user driver score from the vehicle telematics data (e.g., via the driver score analysis component 362). At block 680, the vehicle sharing system 300 (e.g., rate detection component 360) determines a vehicle sharing rate for the shared vehicle based on the vehicle user driver score. For example, for a superior vehicle user driver score, the vehicle sharing rate may be lower than for an inferior vehicle user driver score.

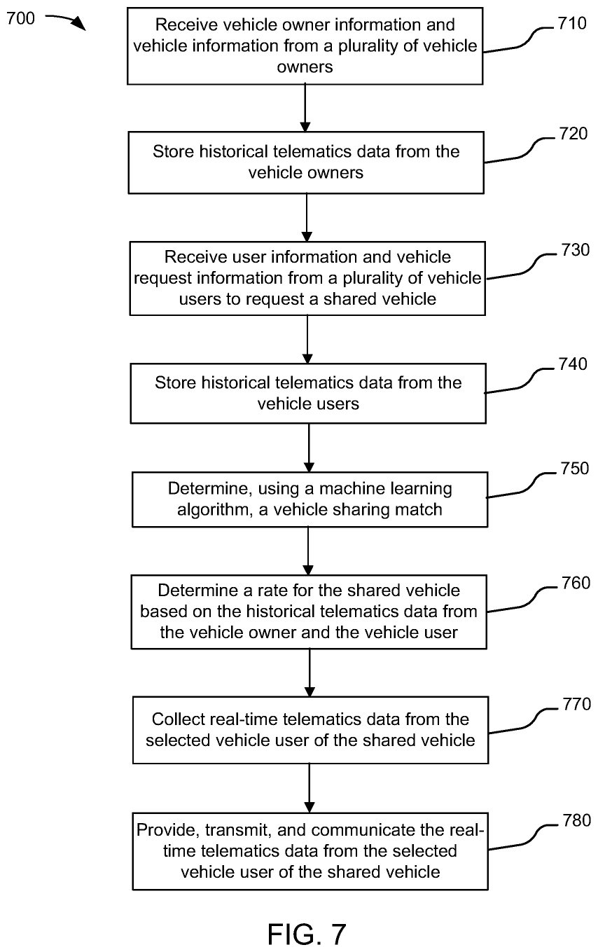

FIG. 7 is a flow diagram illustrating example operations 700, in accordance with certain aspects of the present disclosure. In some aspects, the operations 700 may be performed by the vehicle sharing system 300 including the matching component 330, and/or the rate detection component 360.

At block 710, the vehicle sharing system 300 receives vehicle owner information and vehicle information from a plurality of vehicle owners to commit a shared vehicle on a vehicle sharing application 121. The vehicle sharing application 121 may execute on the vehicle sharing system 300. The vehicle owner information may include one or more of the following: vehicle owner location, vehicle owner social media connections, and vehicle owner community affiliations. The vehicle information may include one or more of the following: vehicle utilization by the vehicle owner, vehicle make and model, vehicle features, or vehicle conditions.

At block 720, the vehicle sharing system 300 retrieves historical telematics data associated with the vehicle owners. The historical telematics data may include, for example, driving events that can or may lead to damage, such as high speed, high acceleration, hard braking, dangerous turns, etc. The historical telematics data may also include a vehicle owner driver score.

At block 730, the vehicle sharing system 300 receives user information and vehicle request information from a plurality of vehicle users to request a shared vehicle on a vehicle sharing application. The user information may include one or more of the following: user location, user social media connections, and user community affiliations. The vehicle request information may include one or more of the following: vehicle needs of the vehicle user, vehicle request make and model, vehicle request features, and vehicle request condition.

At block 740, the vehicle sharing system 300 retrieves historical telematics data associated with the vehicle users. The historical telematics data may include, for example, driving events that can or may lead to damage, such as high speed, high acceleration, hard braking, dangerous turns, etc. The historical telematics data may also include a vehicle user driver score.

At block 750, the vehicle sharing system 300 determines (e.g., via the matching component 330 which may include a machine learning algorithm) a vehicle sharing match between one of the plurality of vehicle owners and one of the plurality of vehicle users. The vehicle sharing match may be based on one or more of the following: matching the vehicle owner location with the vehicle user location within a proximity distance, matching the vehicle owner social media connections with the vehicle user social media connections, or matching the vehicle owner community affiliations with the vehicle user community affiliations. The vehicle sharing match may also be based on matching the vehicle information and the vehicle request information. The vehicle sharing match may also be based on the historical vehicle sharing owner ratings and the historical vehicle sharing user ratings. The matching component 330 may consider one or more of the following factors for the vehicle sharing match: location; degrees of separation (same groups, same friends); scores and ratings (e.g., driving score, reputation score, or vehicle sharing score); whether the user previously drove vehicle owned by a person connected to one of the owner's friends, neighbors, or groups; whether the owner previously provided a vehicle to a person connected to one of the user's friends, neighbors, or groups; previous ratings of the vehicle owner; previous ratings of the vehicle user; whether the user (or owner) previously drove (or provided) a vehicle in same zip code or neighborhood as the owner (or user); vehicle owner and vehicle user reputation score; matching of the same type of driving behavior (vehicle owner and user); matching of the same type of driving score (vehicle owner and user); or price range of the vehicle.

At block 760, the vehicle sharing system 300 determines a vehicle sharing rate (e.g., price) for the shared vehicle based on the historical telematics data from the vehicle owner and the vehicle user. For example, for a superior historical telematics data from the vehicle owner, the vehicle sharing rate may be higher than for an inferior historical telematics data from the vehicle owner because the vehicle owner has been a good driver for the shared vehicle and theoretically, the shared vehicle is in better condition. On the other hand, for superior historical telematics data from the vehicle user, the vehicle sharing rate may be lower than for inferior historical telematics data from the vehicle user because there will be less chance and risk the vehicle user will treat the shared vehicle poorly.

At block 770, the vehicle sharing system collects real-time telematics data from the shared vehicle during the operation of the shared vehicle. The real-time telematics data will be based on driving data from the selected vehicle user of the shared vehicle. Specifically, a telematics device 140 connected to the vehicle sharing application 121 executing on the vehicle sharing system 300 may collect the telematics data. The real-time telematics data may include, but not be limited to, driving events that can or may lead to damage, such as high speed, high acceleration, hard braking, dangerous turns, etc.

At block 780, the vehicle sharing system 300 provides, transmits, and communicates the real-time telematics data from the selected vehicle user of the shared vehicle to a computing device of the vehicle owner. This communication of real-time telematics data may allow the vehicle owner to monitor, in real-time, the driving behavior of the vehicle user of the shared vehicle.

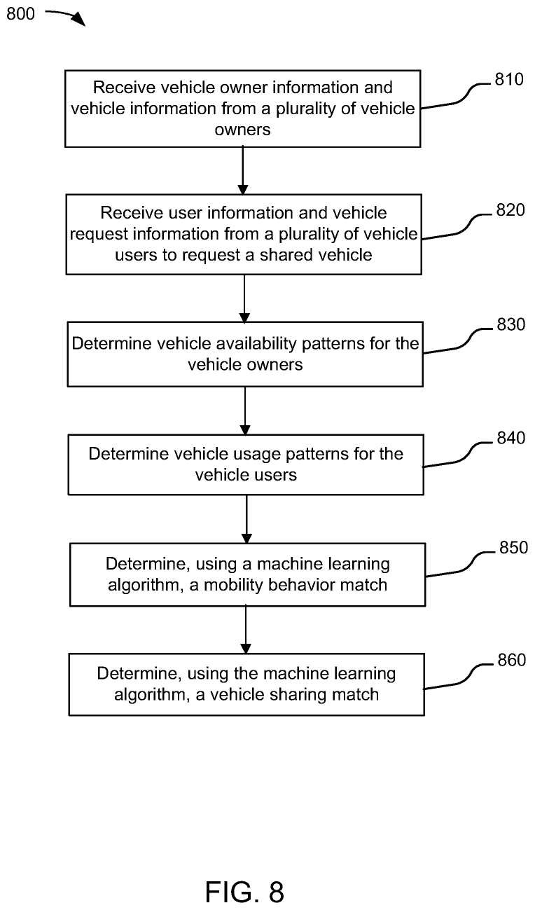

FIG. 8 is a flow diagram illustrating example operations 800 for vehicle sharing, in accordance with certain aspects of the present disclosure. Operations 800 implement matching of vehicles using mobility behavior of owners matched with inverse mobility behavior of users. In some aspects, operations 800 may be performed by the vehicle sharing system 300 including the pattern recognition component 390.

At block 810, the vehicle sharing system 300 receives vehicle owner information and vehicle information from a plurality of vehicle owners to commit a shared vehicle on a vehicle sharing application 121. The vehicle sharing application 121 may execute on the vehicle sharing system 300. The vehicle owner information may include one or more of the following: vehicle owner location, vehicle owner social media connections, or vehicle owner community affiliations. The vehicle information may include one or more of the following: vehicle utilization by the vehicle owner, vehicle make and model, vehicle features, or vehicle conditions.

At block 820, the vehicle sharing system 300 receives user information and vehicle request information from a plurality of vehicle users to request a shared vehicle on a vehicle sharing application. The user information may include one or more of the following: user location, user social media connections, or user community affiliations. The vehicle request information may include one or more of the following: vehicle needs of the vehicle user, vehicle request make and model, vehicle request features, or vehicle request condition.

At block 830, the vehicle sharing system 300 determines vehicle availability patterns of each of the plurality of vehicle owners. The vehicle availability patterns are determined based on when the vehicle owner is driving the vehicle and not driving the vehicle. At block 840, the vehicle sharing system 300 determines vehicle usage patterns of each of the plurality of vehicle users. The vehicle usage patterns are determined based on when the vehicle user is driving the vehicle and not driving the vehicle.

At block 850, the vehicle sharing system 300, using a machine learning algorithm, determines a mobility behavior match from one of the plurality of vehicle owners with one of the plurality of vehicle users based on an inverse-match of the one or more vehicle availably patterns of the vehicle owner with the one or more vehicle usage patterns of the vehicle user. For example, person A (vehicle owner) uses a vehicle on weekends, but not during the week may be matched with person B (vehicle user) who uses a vehicle on a weekday, but not during the weekends.

At block 860, the vehicle sharing system 300 determines, using the machine learning algorithm, a vehicle sharing match from the mobility behavior match and between the one of the plurality of vehicle owners and the one of the plurality of vehicle users. The vehicle sharing match may be based on one or more of the following: matching the vehicle owner location with the vehicle user location within a proximity distance, matching the vehicle owner social media connections with the vehicle user social media connections, or matching the vehicle owner community affiliations with the vehicle user community affiliations. The vehicle sharing match may also be based on matching the vehicle information and the vehicle request information. The vehicle sharing match may also be based on the historical vehicle sharing owner ratings and the historical vehicle sharing user ratings.

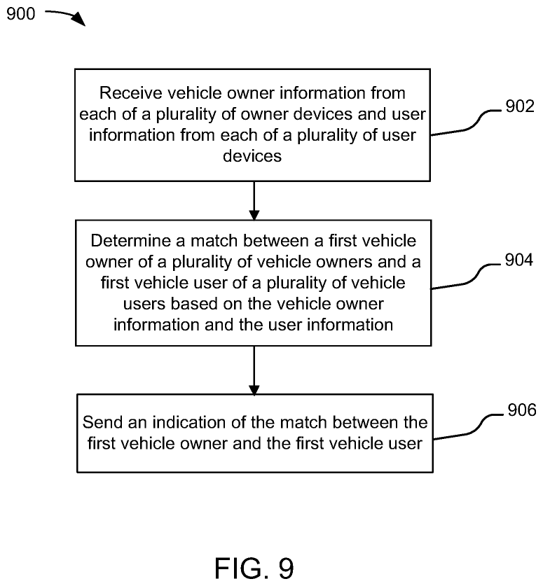

FIG. 9 is a flow diagram illustrating example operations 900 for vehicle sharing, in accordance with certain aspects of the present disclosure. The operations may be performed using a vehicle sharing system, such as the vehicle sharing system 300.

At block 902, the vehicle sharing system may receive (e.g., via data collection component 101) vehicle owner information from each of a plurality of owner devices and user information from each of a plurality of user devices. The data collection component may be in communication with the plurality of user devices and the plurality of owner devices over a network. Each of the plurality of owner devices may be associated with a corresponding vehicle owner of a plurality of vehicle owners and each of the plurality of user devices associated with a corresponding vehicle user of a plurality of vehicle users, the plurality of vehicle owners providing corresponding vehicles and each of the plurality of vehicle users requesting vehicle sharing.

At block 904, the vehicle sharing system determines (e.g., via matching component 330) a match between a first vehicle owner of the plurality of vehicle owners and a first vehicle user of the plurality of vehicle users based on the vehicle owner information and the user information, the vehicle owner information including vehicle owner social data and the user information including vehicle user social data. The matching component may execute a machine-learning algorithm to determine the match between the vehicle owner and the vehicle user.

In some aspects, the matching component determines the match based on an association between one or more social media connections of the first vehicle owner and one or more social media connections of the first vehicle user. In some aspects, the matching component determines the match based on an association between one or more community affiliations of the first vehicle owner and one or more community affiliations of the first vehicle user.

At block 906, the vehicle sharing system sends (e.g., via a communication interface) an indication of the match between the first vehicle owner and the first vehicle user, the indication specifying a first vehicle of the corresponding vehicles, the first vehicle associated with the first vehicle owner.

In some aspects, the vehicle sharing system determines (e.g., via a proximity detection component 392) whether the first vehicle is within a distance from the first vehicle user. The matching component may determine the match based on whether the first vehicle is within the distance from the first vehicle user.

In some aspects, the vehicle sharing system receives (e.g., via the data collection component 101) vehicle information associated with the corresponding vehicles and vehicle request information from the plurality of vehicle users, the matching component further determining the match based on the vehicle information and the vehicle request information. In some aspects, the data collection component obtains driving data while the first vehicle user is driving the first vehicle, the driving data is captured using a telematics device associated with the first vehicle, and the communication interface sends the driving data to the first vehicle owner.

In some aspects, the vehicle sharing system determines (e.g., via a driver score analysis component 362) at least one driver score associated with at least one of the first vehicle user or the first vehicle owner, and determines (e.g., via a rate detection component 360) a vehicle sharing rate for sharing the first vehicle with the first vehicle user based on the at least one driver score, wherein the communication interface is further sending a notification of the vehicle sharing rate. In some aspects, the data collection component receives one or more ratings of at least one of the first vehicle owner or the first vehicle user associated with sharing the first vehicle, and stores the one or more ratings (e.g., in memory 113).

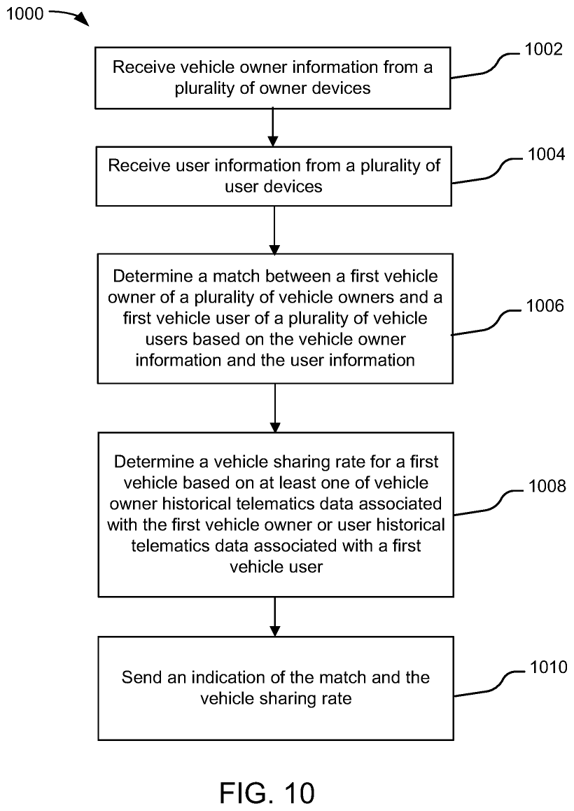

FIG. 10 is a flow diagram illustrating example operations 1000 for vehicle sharing, in accordance with certain aspects of the present disclosure. The operations may be performed using a vehicle sharing system, such as the vehicle sharing system 300.

At block 1002, the vehicle sharing system may receive vehicle owner information from a plurality of owner devices by a data collection component (e.g., data collection component 101) of a vehicle sharing system, each of the plurality of owner devices associated with a corresponding vehicle owner of a plurality of vehicle owners, the plurality of vehicle owners providing corresponding vehicles. At block 1004, the vehicle sharing system receives user information from a plurality of user devices, each of the plurality of user devices associated with a corresponding vehicle user of a plurality of vehicle users, each of the plurality of vehicle users requesting vehicle sharing. In some aspects, the vehicle owner information includes at least one of a vehicle location, one or more vehicle owner social media connections, or one or more vehicle owner community affiliations, and the user information includes at least one of a user location, one or more user social media connections, or one or more user community affiliations.

At block 1006, the vehicle sharing system determines a match between a first vehicle owner of the plurality of vehicle owners and a first vehicle user of the plurality of vehicle users based on the vehicle owner information and the user information, the match specifying a first vehicle of the corresponding vehicles, the first vehicle associated with the first vehicle owner, the match determined using a matching component (e.g., matching component 330) of the vehicle sharing system. In some aspects, determining the match includes finding, via a social data analysis component (e.g., social data analysis component 332) of the vehicle sharing system, an association between one or more community affiliations of the first vehicle owner and one or more community affiliations of the first vehicle user. In some aspects, determining the match includes determining, at a proximity detection component (e.g., proximity detection component 392) of the vehicle sharing system, whether the first vehicle of the first vehicle owner is within a distance from the first vehicle user. In some aspects, the vehicle sharing system receives vehicle information associated with the first vehicle, and receives vehicle request information from the first vehicle user, the match being further determined based on the vehicle information and the vehicle request information.

At block 1008, the vehicle sharing system determines a vehicle sharing rate for the first vehicle based on at least one of vehicle owner historical telematics data associated with the first vehicle owner or user historical telematics data associated with the first vehicle user, the vehicle sharing rate determined by a rate detection component (e.g., rate detection component 360) of the vehicle sharing system. In some aspects, the vehicle sharing system determines determining a driver score associated with the first vehicle user using a driver score analysis component (e.g., driver score analysis component 362) of the vehicle sharing system and based on the user historical telematics data, and determines a driver score associated with the first vehicle owner based on the vehicle owner historical telematics data, the vehicle sharing rate determined based on the driver score associated with the first vehicle owner and the driver score associated with the first vehicle user.

At block 1010, the vehicle sharing system sends an indication of the match and the vehicle sharing rate to a first owner device of the plurality of owner devices and a first user vehicle of the plurality of user devices, the first owner device associated with the first vehicle owner and the first user device associated with the first vehicle user. In some aspects, the vehicle sharing system obtains real-time telematics data while the first vehicle user is operating the first vehicle, and provides the telematics data to the first owner device in real-time to the vehicle owner while the first vehicle user is operating the first vehicle.

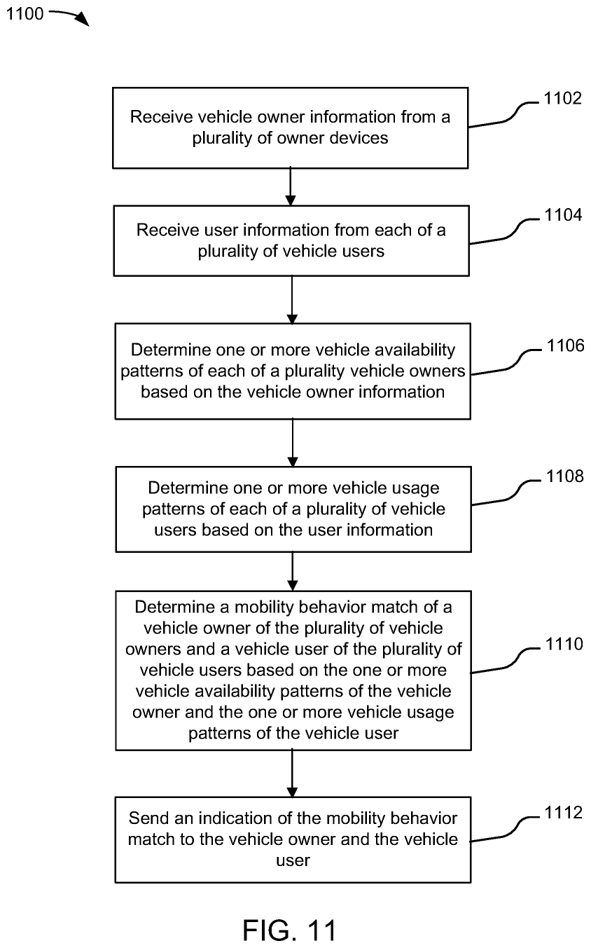

FIG. 11 is a flow diagram illustrating example operations 1100 for vehicle sharing, in accordance with certain aspects of the present disclosure. The operations may be performed using a vehicle sharing system, such as the vehicle sharing system 300.

At block 1102, the vehicle sharing system receives vehicle owner information from a plurality of owner devices by a data collection component (e.g., data collection component 101) of a vehicle sharing system, each of the plurality of owner devices associated with a corresponding vehicle owner of a plurality of vehicle owners, the plurality of vehicle owners providing corresponding vehicles. At block 1104, the vehicle sharing system receives (e.g., via the data collection component 101) user information from a plurality of user devices, each of the plurality of user devices associated with a corresponding vehicle user of a plurality of vehicle users, each of the plurality of vehicle users requesting vehicle sharing.

At block 1106, the vehicle sharing system determines (e.g., via a pattern recognition component 390) one or more vehicle availability patterns of each of the plurality of vehicle owners based on the vehicle owner information. At block 1108, the vehicle sharing system determines (e.g., via the pattern recognition component) one or more vehicle usage patterns of each of the plurality of vehicle users based on the user information.

At block 1110, the vehicle sharing system determines (e.g., via the pattern recognition component) a mobility behavior match of a first vehicle owner of the plurality of vehicle owners and a first vehicle user of the plurality of vehicle users based on the one or more vehicle availability patterns of the first vehicle owner and the one or more vehicle usage patterns of the first vehicle user. In some aspects, the mobility behavior match is determined based on one or more time periods when the first vehicle owner has a vehicle opening and the first vehicle user has a vehicle need.

At block 1112, the vehicle sharing system generates (e.g., via the communication interface 111) an indication of the mobility behavior match, the indication of the mobility behavior match sent to at least one of a first owner device of the plurality of owner devices or a first user device of the plurality of user devices, the first owner device associated with the first vehicle owner and the first user device associated with the vehicle user.

In some aspects, the vehicle sharing system determines a match between the first vehicle owner and the first vehicle user based on social data associated with the first vehicle owner and the first vehicle user, the indication further including the match. The match may be determined based on an association between one or more social media connections of the first vehicle owner and one or more social media connections of the first vehicle user.

Implementations of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an implementation in the present disclosure can be references to the same implementation or any implementation; and, such references mean at least one of the implementations.

Reference to “one implementation” or “an implementation” means that a particular feature, structure, or characteristic described in connection with the implementation is included in at least one implementation of the disclosure. The appearances of the phrase “in one implementation” in various places in the specification are not necessarily all referring to the same implementation, nor are separate or alternative implementations mutually exclusive of other implementations. Moreover, various features are described which may be exhibited by some implementations and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various implementations given in this specification.

Without intent to limit the scope of the disclosure, examples of instruments, apparatus, methods and their related results according to the implementations of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

As will be appreciated by one of skill in the art upon reading the following disclosure, various aspects described herein can be a method, a computer system, or a computer program product. Accordingly, those aspects can take the form of an entirely hardware implementation, an entirely software implementation, or at least one implementation combining software and hardware aspects. Furthermore, such aspects can take the form of a computer program product stored by one or more computer-readable storage media having computer-readable program code, or instructions, included in or on the storage media. Any suitable non-transitory computer-readable storage media (medium) can be utilized, including hard disks, CD-ROMs, optical storage devices, magnetic storage devices, and/or any combination thereof. In addition, various signals representing data or events as described herein can be transferred between a source and a destination in the form of electromagnetic waves traveling through signal-conducting media such as metal wires, optical fibers, and/or wireless transmission media (e.g., air and/or space).

1. A vehicle sharing system comprising:
a data collection component in communication with a plurality of user devices and a plurality of owner devices over a network, each of the plurality of owner devices associated with a corresponding vehicle owner of a plurality of vehicle owners and each of the plurality of user devices associated with a corresponding vehicle user of a plurality of vehicle users, the plurality of vehicle owners providing corresponding vehicles and each of the plurality of vehicle users requesting vehicle sharing, the data collection component receiving vehicle owner information from each of the plurality of owner devices and user information from each of the plurality of user devices;
a matching component configured to determine a match between a first vehicle owner of the plurality of vehicle owners and a first vehicle user of the plurality of vehicle users based on the vehicle owner information and the user information, the vehicle owner information including vehicle owner social data and the user information including vehicle user social data; and
a communication interface configured to send an indication of the match between the first vehicle owner and the first vehicle user, the indication specifying a first vehicle of the corresponding vehicles, the first vehicle associated with the first vehicle owner.

2. The vehicle sharing system of claim 1, wherein the matching component determines the match based on an association between one or more social media connections of the first vehicle owner and one or more social media connections of the first vehicle user.

3. The vehicle sharing system of claim 1, wherein the matching component determines the match based on an association between one or more community affiliations of the first vehicle owner and one or more community affiliations of the first vehicle user.

4. The vehicle sharing system of claim 1, further comprising:
a proximity detection component configured to determine whether the first vehicle is within a distance from the first vehicle user, the matching component determining the match based on whether the first vehicle is within the distance from the first vehicle user.

5. The vehicle sharing system of claim 1, wherein the data collection component is further configured to receive vehicle information associated with the corresponding vehicles and vehicle request information from the plurality of vehicle users, the matching component further determining the match based on the vehicle information and the vehicle request information.

6. The vehicle sharing system of claim 1, wherein:
the data collection component is further configured to obtain driving data while the first vehicle user is driving the first vehicle, the driving data captured using a telematics device associated with the first vehicle; and
the communication interface is further configured to send the driving data to the first vehicle owner.

7. The vehicle sharing system of claim 1, further comprising:
a driver score analysis component configured to determine at least one driver score associated with at least one of the first vehicle user or the first vehicle owner; and
a rate detection component configured to determine a vehicle sharing rate for sharing the first vehicle with the first vehicle user based on the at least one driver score, wherein the communication interface is further configured to send a notification of the vehicle sharing rate.

8. The vehicle sharing system of claim 1, wherein the data collection component is further configured to:
receive one or more ratings of at least one of the first vehicle owner or the first vehicle user associated with sharing the first vehicle; and
store the one or more ratings.

9. The vehicle sharing system of claim 1, wherein the matching component executes a machine learning algorithm configured to determine the match between the vehicle owner and the vehicle user.

10. A method for vehicle sharing, the method comprising:
receiving vehicle owner information from a plurality of owner devices by a data collection component of a vehicle sharing system, each of the plurality of owner devices associated with a corresponding vehicle owner of a plurality of vehicle owners, the plurality of vehicle owners providing corresponding vehicles;
receiving user information from a plurality of user devices, each of the plurality of user devices associated with a corresponding vehicle user of a plurality of vehicle users, each of the plurality of vehicle users requesting vehicle sharing;
determining a match between a first vehicle owner of the plurality of vehicle owners and a first vehicle user of the plurality of vehicle users based on the vehicle owner information and the user information, the match specifying a first vehicle of the corresponding vehicles, the first vehicle associated with the first vehicle owner, the match determined using a matching component of the vehicle sharing system;
determining a vehicle sharing rate for the first vehicle based on at least one of vehicle owner historical telematics data associated with the first vehicle owner or user historical telematics data associated with the first vehicle user, the vehicle sharing rate determined by a rate detection component of the vehicle sharing system; and
sending an indication of the match and the vehicle sharing rate to a first owner device of the plurality of owner devices and a first user vehicle of the plurality of user devices, the first owner device associated with the first vehicle owner and the first user device associated with the first vehicle user.

11. The method of claim 10, further comprising:
obtaining real-time telematics data while the first vehicle user is operating the first vehicle; and
providing the telematics data to the first owner device in real-time to the vehicle owner while the first vehicle user is operating the first vehicle.

12. The method of claim 10, wherein:
the vehicle owner information includes at least one of a vehicle location, one or more vehicle owner social media connections, or one or more vehicle owner community affiliations; and
the user information includes at least one of a user location, one or more user social media connections, or one or more user community affiliations.

13. The method of claim 10, wherein determining the match comprises finding, via a social data analysis component of the vehicle sharing system, an association between one or more community affiliations of the first vehicle owner and one or more community affiliations of the first vehicle user.

14. The method of claim 10, wherein determining the match comprises determining, at a proximity detection component of the vehicle sharing system, whether the first vehicle of the first vehicle owner is within a distance from the first vehicle user.

15. The method of claim 10, further comprising:
receiving vehicle information associated with the first vehicle; and
receiving vehicle request information from the first vehicle user, the match further determined based on the vehicle information and the vehicle request information.

16. The method of claim 10, further comprising:
determining a driver score associated with the first vehicle user using a driver score analysis component of the vehicle sharing system and based on the user historical telematics data; and
determining a driver score associated with the first vehicle owner based on the vehicle owner historical telematics data, the vehicle sharing rate determined based on the driver score associated with the first vehicle owner and the driver score associated with the first vehicle user.

17. One or more tangible non-transitory computer-readable storage media storing computer-executable instructions for performing a computer process on a computing system, the computer process comprising:
receiving vehicle owner information from a plurality of owner devices by a data collection component of a vehicle sharing system, each of the plurality of owner devices associated with a corresponding vehicle owner of a plurality of vehicle owners, the plurality of vehicle owners providing corresponding vehicles;
receiving user information from a plurality of user devices, each of the plurality of user devices associated with a corresponding vehicle user of a plurality of vehicle users, each of the plurality of vehicle users requesting vehicle sharing;
determining one or more vehicle availability patterns of each of the plurality of vehicle owners based on the vehicle owner information;
determining one or more vehicle usage patterns of each of the plurality of vehicle users based on the user information;
determining a mobility behavior match of a first vehicle owner of the plurality of vehicle owners and a first vehicle user of the plurality of vehicle users based on the one or more vehicle availability patterns of the first vehicle owner and the one or more vehicle usage patterns of the first vehicle user; and
generating an indication of the mobility behavior match, the indication of the mobility behavior match sent to at least one of a first owner device of the plurality of owner devices or a first user device of the plurality of user devices, the first owner device associated with the first vehicle owner and the first user device associated with the vehicle user.

18. The one or more non-transitory computer-readable storage media of claim 17, the mobility behavior match is determined based on one or more time periods when the first vehicle owner has a vehicle opening and the first vehicle user has a vehicle need.

19. The one or more non-transitory computer-readable storage media of claim 17, the computer process further comprising:
determining a match between the first vehicle owner and the first vehicle user based on social data associated with the first vehicle owner and the first vehicle user, the indication further including the match.

20. The one or more non-transitory computer-readable storage media claim 19, wherein the match is determined based on an association between one or more social media connections of the first vehicle owner and one or more social media connections of the first vehicle user.
